(19) United States
(12) Patent Application Publication
(10) Pub. No.: US 2011/0126293 A1
(43) Pub. Date: May 26, 2011

(54) SYSTEM AND METHOD FOR CONTEXTUAL AND BEHAVIORAL BASED DATA ACCESS CONTROL

(76) Inventors: Pavel Berengoltz, Petah-Tikva (IL); Hay Hazama, Kiryat Ono (IL); On Freund, Savyon (IL)

(21) Appl. No.: 12/810,904

(22) PCT Filed: Dec. 25, 2008
(86) PCT No.: PCT/IL08/01681

§ 371 Date: Jan. 7, 2011

(30) Foreign Application Priority Data
Dec. 27, 2007 (US) 61/009160

(51) Int. Cl. G06F 21/24

(52) U.S. Cl. 726/26

(57) ABSTRACT

A system and method of controlling access to information. An encrypted version of the information is stored. An attempt to access encrypted information may be intercepted and an access authorization rank may be computed. If computed access authorization rank is above a predefined level then a decrypted version of the information may be provided. Other embodiments are described and claimed.

### BACKGROUND OF THE INVENTION

A large and increasing portion of the information handled in today's modern office environment is digital. Many organizations, institutions and establishments store, handle and manipulate most of their information, and/or information associated with their activities, in digital forms. In many cases, such information may include confidential, secret or otherwise sensitive information, which, in the wrong hands, may cause serious damage to the owner or keeper of the information and/or to those associated with the owner and/or keeper of the information.

Uncontrolled information flow, also, is a recognized problem in various industries, organizations and environments. For example, commercial organizations, government agencies, academic institutions and health care facilities may all be at risk of sensitive information being provided to unauthorized, possibly hostile entities.

Much attention has been devoted to devising methods for preventing sensitive information from being provided to unauthorized entities, for example by encrypting the information. However, forcing a user to provide a password or key each time a file or other type of information is accessed may have costly consequences on productivity. Enabling access, for example, based on a computer boot sequence or a user login may prove to be insufficient since destructive and/or malicious programs such as trojan horses, viruses or worms may access sensitive content that may be made available upon user login.

### SUMMARY OF EMBODIMENTS OF THE INVENTION

Embodiments of the invention generally relate to controlling of access to information. According to embodiments of the invention, an attempt to access encrypted digital information may be intercepted and an access authorization rank may be computed. According to embodiments of the invention, computing an access authorization rank may be according to a context in which the access attempt is performed. According to embodiments of the invention, access may be granted according to a computed access authorization rank.

According to embodiments of the invention, if access is granted then a decrypted version of the encrypted information is provided.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic flow chart according to embodiments of the invention; and

FIG. 2 is a schematic block diagram according to embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

Embodiments of the invention generally relate to controlling access to information. According to embodiments of the invention, an attempt to access encrypted digital information may be intercepted and an access authorization rank may be computed. According to embodiments of the invention, an access authorization rank may be computed according to a context in which the access attempt is performed. According to embodiments of the invention, access may be granted or denied according to a computed access authorization rank. According to embodiments of the invention, if access is granted then a decrypted version of the encrypted information is provided.

The term “context” used in this patent application should be expansively construed to include any parameters or information applicable and/or relevant to an attempt to access information. For example, according to embodiments of the invention, the context with in which an attempt to access information is made may include user related information, identification and/or parameters, device information and/or parameters, network connectivity state and/or mode, information and parameters pertaining to associated application, tasks and/or processes, behavioral patterns, user defined context parameters, surroundings, situation, location, locale, circumstances, frameworks, backgrounds, perspectives, conditions or events that form the environment within which an attempt to access information takes place.

The phrase “attempt to access information” used in this patent application should be expansively construed to include any attempt to access digital information. For example, an attempt to access information may comprise attempting to read, modify, copy, duplicate, overwrite, concatenate or otherwise manipulate digital information. According to embodiments of the invention, an attempt to access information may further include attempting to modify metadata associated with information, for example, attempting to modify or change a file's creation date, modification date, ownership, location or any other associated information and/or attributes. It should be noted that an attempt to access information may be performed by a user or by a program, application, process or any other executable software entity. The terms, program, application and process will be used in this patent application interchangeably and should expansively construed to include any executable software entity.

The phrase “access authorization rank” used in this patent application should be expansively construed to include any parameters or information pertaining to access rights, authorization, privileges, mode, permissions or any other applicable parameters or information that may influence access to information or actions associated with information.

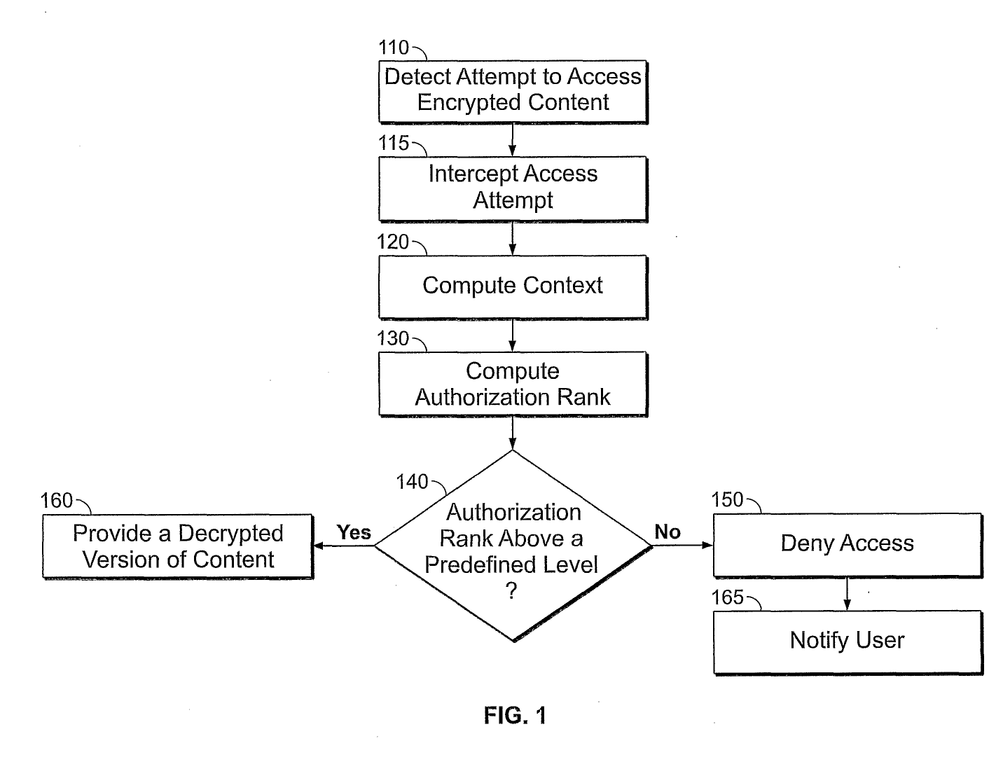

Reference is made to FIG. 1 showing an exemplary flow chart according to embodiments of the invention. According to embodiments of the invention and as indicated by block 110, the flow may include a detection of an attempt to access encrypted information. For example, a user operating a computer may attempt read a file on her computer or an application may attempt to delete a file on an external storage device, e.g. a universal serial bus (USB) storage device.

According to embodiments of the invention and as indicated by block 115, the flow may include an interception of an attempt to access information. According to embodiments of the invention, such interception may be performed by a module configured to detect events comprising access to information. For example, a software module may be configured to detect and intercept events comprising reference to a storage device. According to embodiments of the invention, such events may be detected by detecting an invocation of a device driver. For example, an invocation of a device driver handling a hard disk drive, a device driver handling a removable media drive, a device driver handling a network interface card (NIC) or any device driver handling a device or interface that may be associated with stored, or otherwise accessible information.

According to embodiments of the invention and as indicated by block 120, the flow may include computing a context. According to embodiments of the invention, a computation of a context may be in association with an attempt to access information. According to embodiments of the invention, a computation of a context may comprise collecting information and parameters that may be relevant to the access attempt, for example, parameters and information described above as comprising a context.

According to embodiments of the invention and as indicated by block 130, the flow may include computing an access authorization rank. According to embodiments of the invention, an access authorization rank may be computed according and/or relative to a context. For example, the access authorization rank for a specific information object may vary according to a context parameter such as network connectivity. In such example, an access authorization rank reflecting a read only permission may be computed for a specific application attempting to access the specific information object when network connectivity is available while an access authorization rank reflecting read and write permissions for the same application attempting to access the same specific information object may be computed when network connectivity is unavailable. A configuration such as described above may be desirable in order to ensure that certain information can not be modified by users who login to a computer over a network but only modified by a person who is operating the computer locally. Such configuration may possibly include restricted physical access to the computer.

According to embodiments of the invention, an access authorization rank may reflect attributes associated with an access to information as well as attributes associated with further actions as described above. For example, according to embodiments of the invention, an access authorization rank may allow a user or application to access an information object and may further allow the accessing entity to modify the information. In other cases, according to embodiments of the invention, an access authorization rank may allow a user to access an information object but restrict the access to read or view only. According to embodiments of the invention, predefined access authorization ranks may reflect various access rights, privileges and modes.

According to embodiments of the invention and as indicated by block 140, the flow may include determining whether a computed access authorization rank is above a predefined access authorization rank. According to embodiments of the invention, a computed access authorization rank may be compared with a predefined access authorization rank associated with the information being accessed. According to embodiments of the invention, different predefined access authorization ranks may be assigned to different information objects. For example, predefined access authorization ranks may be assigned to specific files, file types, folders or devices. According to embodiments of the invention, a predefined access authorization rank may be hierarchical, for example, a predefined access authorization rank assigned to a folder may be associated with any information contained in that folder, or a predefined access authorization rank assigned to a device may be associated with any information stored on that device.

According to embodiments of the invention and as indicated by block 150, the flow may include denying access to information. According to embodiments of the invention, if a computed access authorization rank, for example as shown by block 130, is lower than a predefined access authorization rank associated with the information to which an access attempt is made, then access may be denied. According to embodiments of the invention and as indicated by block 165, the flow may include informing a user that access was denied. According to embodiments of the invention informing the user may be accomplished by any suitable means such as, but not limited to visual and/or audio effects, for example, a message displayed on a computer display. In some embodiments of the invention, a report may additionally or alternatively be sent to a central server, or to a system administrator. According to embodiments of the invention and as indicated by block 160, the flow may further include providing a decrypted version of the information if access authorization rank is above a predefined level based on the decision block 140.

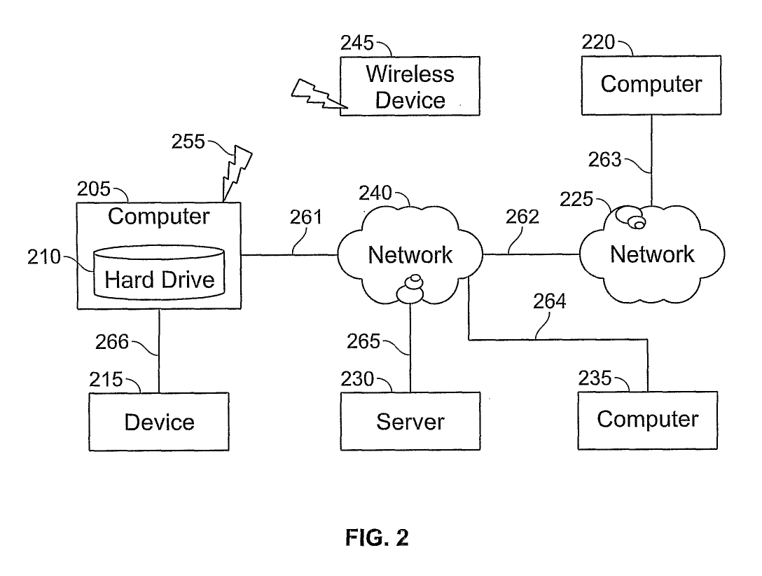

Reference is made to FIG. 2 showing exemplary components according to embodiments of the invention. According to embodiments of the invention, computers 205, 220 and 230 and server 235 may each be any of a personal computer, a desktop computer, a mobile computer, a laptop computer, a notebook computer, a workstation, a server computer, a personal digital assistant (PDA) device, a tablet computer, a network device, or any other suitable computing device. Computer 205 may further include hard drive 210 that may be used to store information. Computer 205 may be further equipped with antenna 255. Antenna 255 may enable computer 205 to communicate wirelessly with wireless devices such as wireless device 245. Device 245 may be a computer similar to computers 205 or it may be a storage device, a cellular phone, a wireless personal digital assistant (PDA) device, a WiFi device, a Bluetooth device, an IrDA device or any other device capable of storing and/or providing digital information or content. According to embodiments of the invention, computer 205 may be connected to network 240 over communication medium 261.

According to embodiments of the invention, computer 205 may be connected, over communication medium 266, to one or more devices such as device 215. According to embodiments of the invention, device 215 may be a volatile storage chip device, an external hard drive, a removable media device or drive, a USB storage device, a FLASH storage device, a peripheral component interconnect (PCI) compatible device or any other suitable device capable of storing and/or providing digital information. According to embodiments of the invention, device 215 may further include an operating system (OS) such as, but not limited to Windows CE™, Linux, Palm OS™, Solaris™, MAC OS™, a micro kernel or any other suitable OS.

According to embodiments of the invention, computer 205 may be connected to network 240 over communication medium 261. Network 240 may be a private IP network, an integrated services digital network (ISDN) line, a frame relay connection, a modem connected to a phone line or a public switched telephone network (PSTN), private data network, a local area network (LAN), an enterprise intranet or any other suitable communication means or combination of the preceding.

According to embodiments of the invention, Network 240 may be connected to network 225 over communication medium 262. Network 225 may be a private IP network, a public network, the interne, an integrated services digital network (ISDN) line, a frame relay connection, a modem connected to a phone line or a public switched telephone network (PSTN), a public or private data network, a local area network (LAN), a metropolitan area network (MAN), a wide area network (WAN), an enterprise intranet or any other suitable communication means or combination of the preceding. According to embodiments of the invention, computer 220 may be connected to network 225 over communication medium 263. According to embodiments of the invention, computer 220 may be a web server or any other computer comprising the interne.

According to embodiments of the invention, server 230 may be a computer similar to computers 205 and/or 235 or it may be a network storage device. Server 230 may further be equipped to perform server duties. For example, server 230 may comprise extended storage and/or computing capacities. According to embodiments of the invention, server 230 may be connected to network 240 over communication medium 265.

According to embodiments of the invention, access control to information may comprise storing an encrypted version of the information to be protected. For example, an owner or keeper of information, such as an organization, institution or any other establishment or entity may store some or all of its information in encrypted form. According to embodiments of the invention, when information needs to be accessed it may be decrypted, provided some conditions are met, for example, an access authorization rank has an appropriate value as described above. Accordingly, if required conditions and/or criteria are not met then the information may not be decrypted, and consequently, access is denied and/or blocked.

According to embodiments of the invention, a list of applications authorized to access a respective list of information objects may be complied. According to embodiments of the invention, access control to information may be according to such lists. For example, an administrator or a user operating or owning computer 205 may provide embodiments of the invention with a list of applications that are authorized to access information stored on disk 210. According to embodiments of the invention, when an attempt to access an information object stored on disk 210 is detected, the attempt may be intercepted and the accessing application may be checked. According to embodiments of the invention, if the accessing application is included in the provided authorized applications list then access may be permitted and a decrypted version of the information object may be provided. Otherwise, if the accessing application is not included in the provided authorized applications list then access may be denied and the access attempt may be failed and/or aborted, possibly accompanied by a notification to a user.

Alternatively, an administrator or a user operating or owning computer 205 may provide embodiments of the invention with a list of applications that are unauthorized to access information stored on disk 210. Accordingly, when an attempt to access an information object stored on disk 210 is detected, the attempt may be intercepted and the accessing application may be checked. According to embodiments of the invention, if the accessing application is not included in the provided unauthorized applications list then access may be permitted and a decrypted version of the information object may be provided. Otherwise, if the accessing application is included in the provided, unauthorized applications list, then access may be denied and the access attempt may be failed and/or aborted, possibly accompanied by a notification to a user.

According to embodiments of the invention, attempts to access information that are failed or aborted may be recorded and may further trigger an action. According to embodiments of the invention, a log entry, for example in a log file, may be created to record a failed or aborted access attempt. According to embodiments of the invention, an electronic mail may be sent to a predefined recipient list, or a message may communicated over a paging system to a predefined recipient list when an attempt to access information is failed or aborted. According to embodiments of the invention, the information logged and/or communicated when an access attempt is failed and/or aborted may be defined. For example, the information may include parameters such as, but not limited to, identification of the program associated with the failed attempt, a time of day, a computer name and/or identification, information pertaining to the user associated with the failed attempt, for example, user name, user identification, parameters pertaining to the information to which the access attempt was made, for example, a file name, file location or any other relevant information and/or parameters.

According to embodiments of the invention, granting access to information may require user input. For example, embodiments of the invention may be configured such that, when a program, application, process or any other executable software entity attempts to access information stored on server 230 or a peripheral device connected to server 230, a user may be prompted to authorize the access. According to embodiments of the invention, a user may be provided with parameters such as, but not limited to, the application name and/or type, parameters pertaining to the information being accessed, for example, a file name and/or a file location etc. According to embodiments of the invention, possibly based on parameters provided as described, a user may authorize the access. In such case, the encrypted information may be decrypted and the decrypted version of the information may be provided to the application.

According to embodiments of the invention, determining an access authorization rank may further be according to behavioral, execution, and/or flow patterns. According to embodiments of the invention, access to, and/or consumption of information may be tracked, possibly recorded and further evaluated and/or used as input to a decision making logic that may classify various patterns as such that require attention, action and/or intervention. For example, if an application accesses files on server 230 and the access is performed according to a lexicographical order, for example, starting with files names that start with the character “a” and working its way down through to file names that start with the character “z” then it may be assumed that the application is not controlled by a human user but rather a robot application, a virus, or any other self controlled application. In such case, possibly according to additional parameters, further access to files or other information may be blocked by embodiments of the invention. For example, encrypted information stored on server 230 may no longer be decrypted and provided to the application.

According to embodiments of the invention, blocking of access, for example to information stored on server 230 as described above, may be applied globally, e.g. non of the information stored on server 230 may be provided to any application. In other cases, possibly according to some configuration parameters, access may be blocked for some applications, possibly to some of the information while access may still be granted to other applications. According to embodiments of the invention, blocking of access, may further be for a predefined period of time or it may be applied until an authorized user configures the system to allow access, possibly after taking corrective measures. According to embodiments of the invention, a password or other identifying information may be required in order to restore access to information after access was blocked.

According to embodiments of the invention, time parameters associated with access to information may be observed and further used by an access control decision making logic. For example, if the time elapsed between consecutive access attempts by an application is under some predefined value (e.g. an application accessing a large number of files within a very short period of time) then it may be assumed, as described above, that the application is not controlled by a human user and the consequences may be as described above. Another example of a time pattern may be an access that is repeated periodically. For example, an access to information that is repeated daily, possibly at the same time of day and possibly to the same information objects. As described above, such pattern may be identified by embodiments of the invention, it may further be concluded that this access is undesirable and consequently, access may be blocked, according to embodiments of the invention, by refraining to further provide the application with decrypted information.

Another example of a time related parameter that may influence an access authorization rank, according to embodiments of the invention, may be idle or inactivity time. For example, embodiments of the invention may be configured such that access to some or all of the information stored on computer 220 may be granted to an active user that may be logged onto computer 220. According to embodiments of the invention, if an inactivity period above a predefined and/or a preconfigured value is detected then access to information stored on computer 220 may be blocked. Such configuration may enable granting access to information on a computer while an authorized user is operating it but access may be blocked in the absence of the authorized user. According to embodiments of the invention, idle time or inactivity may be determined by tracking events such as, but not limited to, mouse movement or clicks, keyboard key presses or an activation of a screen saver.

According to embodiments of the invention, access control may be context related and/or event driven. According to embodiments of the invention, events that may effect access control may be events such as, but not limited to, a user login, a network connection enabled or disabled, a device connected to a computer or an alert from an application, for example, a security related application. For example, embodiments of the invention may be configured to allow, for all application, access to information stored on computer 235, in such case, a decrypted version of information stored on computer 235 may be provided to any application upon request. However, embodiments of the invention may be further configured such that such access is only granted when connection 264 to network 240 is disabled and/or unavailable. According to embodiments of the invention, in the event connection 264 is restored and/or made available, access to information stored on computer 235 may be blocked. Accordingly, according to embodiments of the invention, in the event connection 264 is made unavailable, access to information stored on computer 235 may be granted.

According to embodiments of the invention, network connectivity may affect access to information on multiple computers. For example, network 240 may be a local area network in an organization while network 225 may be the internet. According to embodiments of the invention, access to information on computers 205, 235 and server 230 may be granted when connection 262 is unavailable, namely, embodiments of the invention may decrypt and provide encrypted information stored on these computers. However, embodiments of the invention may be configured such that in the event that connection 262 is made available, access to information stored on computers 205 and 235 and server 230 may be blocked. Such configuration may protect information stored on computers in an organization from being accessed by external applications or users, for example, users or applications associated with computer 220.

According to embodiments of the invention, access privileges to information may be affected by connectivity between computing devices. For example, access may be permitted to information stored on hard drive 210 if computer 205 is not connected to any external device. Accordingly, embodiments of the invention may decrypt encrypted information stored on hard drive 210 and provide a decrypted version upon request. However, embodiments of the invention may be configured such that when device 215 is connected to computer 205 and connection 266 is operational and available information stored on hard drive 210 is no longer available, namely, information stored on hard drive 210 may not be decrypted when accessed. According to embodiments of the invention, if/when connection 266 is made unavailable then access to information on hard drive 210 may be restored, namely, embodiments of the invention may provide a decrypted version of information stored on hard drive 210 upon request. Such arrangement may disable copying information from hard drive 210 to device 215.

Another example of access control affected by connectivity to a device may be a connection between computer 205 and wireless device 245. According to embodiments of the invention, access to information stored on hard drive 210 may be blocked when connectivity to wireless device 245 is detected. Accordingly, when no connectivity to device 245 is available then access to information stored on hard drive 210 may be granted, for example, embodiments of the invention may decrypt encrypted information stored on hard drive 210 and provide a decrypted version upon request.

According to embodiments of the invention, access to information may be permitted or denied based on user information, parameters and/or attributes. For example, embodiments of the invention may be configured to enable access to information stored on server 230 provided that the user logged onto server 230 is included in a predefined list. According to embodiments of the invention, access may be granted provided the user is further logged in through a console directly attached to server 230. According to embodiments of the invention, if such conditions are met then information stored on server 230 may be readily provided upon request, namely, when access is made to information stored on computer 230, encrypted information stored on computer 230 may be decrypted and the decrypted version may be provided. According to embodiments of the invention, if the user logged onto server 230 through a directly attached console is not included in the above mentioned list then access to information stored on server 230 may be blocked as shown by block 150 of FIG. 1.

According to embodiments of the invention, access to information may be permitted or denied based on input from applications. For example, input from firewall, anti-spyware, anti-virus, port protection or content inspection applications. Such applications may communicate with embodiments of the invention and inform embodiments of the invention of events, conditions or context that may be relevant to information access control. For example, an anti-virus application may alert embodiments of the invention when a virus is detected, in such case, embodiments of the invention may immediately block access to information by, for example, refraining from decrypting encrypted information. Other examples may be a port scanning application that may inform embodiments of the invention of an application that attempts to open a connection to a computer over an unknown or unauthorized port, or a firewall alerting embodiments of the invention of attempts to access a secured zone or network. In such cases, embodiments of the invention may block access as described above, possibly according to additional configuration parameters.

According to embodiments of the invention, access to information may be permitted or denied based on input from authentication devices, such as, but not limited to, smart cards, plugs, or token. For example, device 245 may require an authentication plug to be installed and/or connected in order to enable various features such as network connectivity, user login or access to external devices, such device may be controlled by a software application. According to embodiments of the invention, presence of the authentication plug may be detected and further used as a parameter for access control logic. For example, embodiments of the invention may block access to information stored on device 245 if the authentication plug is not detected, namely, encrypted information stored on device 245 may not be decrypted upon request. According to embodiments of the invention, the software controlling the authentication plug may communicate with embodiments of the invention and further inform embodiments of the invention of presence and status of the authentication plug.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for controlling access to information comprising:
intercepting an attempt to access encrypted information;
determining a context pertaining to said attempt to access said encrypted information;
computing an access authorization rank, wherein said computing is based, at least in part, on said information and said context and a configuration; and
if said access authorization rank is above a predefined threshold then providing a decrypted version of said encrypted information.

2. The method of claim 1 wherein said computing an access level is further based on a state of a connection to a communication network.

3. The method of claim 1 wherein said computing an access authorization rank is further based on a state of a connection to an external device.

4. The method of claim 1 wherein said computing an access authorization rank is further based on a an application identification, wherein said application is used in order to access said encrypted information.

5. The method of claim 1 wherein said computing an access authorization rank is further based on an identification of a user associated with said attempt to access said encrypted information.

6. The method of claim 1 wherein said computing an access authorization rank is further based on a metadata associated with said information.

7. The method of claim 1 wherein said attempt to access said encrypted information further comprises an attempt to perform an action associated with said encrypted information, wherein said action is selected from a group consisting of read, write, copy, modify, delete, move, duplicate, concatenate, and overwrite.

8. The method of claim 1 wherein said access authorization rank is selected from a group consisting of: read, write, copy, modify, delete, move, duplicate, concatenate, and overwrite.

9. The method of claim 1 wherein if said access authorization rank is not above a predefined threshold then failing said attempt to access said encrypted information.

10. The method of claim 9 wherein if said access authorization rank is not above a predefined threshold then recording information pertaining to said attempt to access said encrypted information.

11. The method of claim 9 wherein if said access authorization rank is not above a predefined threshold then communicating information pertaining to said attempt to access said encrypted information.

12. The method of claim 1 wherein said computing an access authorization rank is further based on a presence status of an authentication device.

13. The method of claim 1 wherein said computing an access authorization rank is further based on an inactivity duration parameter.
